(19) United States
(12) Patent Application Publication
(10) Pub. No.: US 2008/0037560 A1
(43) Pub. Date: Feb. 14, 2008

(54) Solution For Routing Scheme In Wireless Communication

(75) Inventors: Bruce Jia, Shanghai (CN); Sun Li, Shanghai (CN); Pan Sheng, Shanghai (CN)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/571,813

(22) PCT Filed: Sep. 8, 2004
(86) PCT No.: PCT/IB04/51709

§ 371 Date: Feb. 5, 2007

(30) Foreign Application Priority Data
Sep. 19, 2003 (CN) 03124914.0

(51) Int. Cl. H04L 12/28

(52) U.S. Cl. 370/400; 370/351

(57) ABSTRACT

The present invention proposes a routing method performed by a mobile terminal in wireless communication systems, comprising: (i) receiving route probing signals to the destination mobile terminal from another mobile terminal; (ii) calculating the route cost to the destination mobile terminal via said mobile terminal according to said route probing signals and system performance parameters; (iii) sending response messages to said another mobile terminal according to the calculated route cost. This method weights the route cost with the number of hops on the route, to address problems introduced by hop-by-hop

### FIELD OF THE INVENTION

The present invention relates generally to a routing method in wireless communication systems, and more particularly, to a routing method during communication process and a mobile terminal to perform the method.

### BACKGROUND OF THE INVENTION

Wireless networks have become increasingly popular in current social life, for their provision of ubiquitous computing capability and information access regardless of the location.

Currently, there are two variations of mobile wireless networks—infrastructure-based mobile wireless network such as cellular networks and WLANs (Wireless Local Area Network), and wireless networks without infrastructure such as mobile ad hoc networks. Generally, in infrastructure-based wireless networks, the coverage range of a base station or AP (access point) determines the size of a cell and the mobile nodes (mobile terminals) camping within the cell connect to and communicate directly with the nearest bridge (base station or access point). While in mobile ad hoc networks, the mobile nodes are self-organizing. Two communicating mobile nodes can still maintain communication with each other when they are out of the radio range provided that they can reach each other via intermediate mobile nodes acting routers that forward packets from source to destination. In infrastructure-based wireless networks, mobile nodes are directly connected to the base station or AP, so infrastructure-based wireless networks are considered as one-hop network. While in mobile ad hoc networks, there usually is no direct link between two mobile nodes and they have to communicate through relaying of other mobile nodes, so mobile ad hoc networks are also called as multi-hop network.

Due to the potential ease of deployment, mobile ad hoc networks are spreading madly to many practical applications, including PAN, HAN, military environments, search-and-rescue operations and so on. Due to the fact that the theoretical total transmission power will be reduced when breaking the direct one-hop link between the mobile node and the base station into multi-hop link with other mobile nodes working as interim relayers, ad hoc networking, especially the relaying communication mechanism is becoming an interesting approach for cellular networks to extend coverage and increase system capacity. FIG. 1 shows an example for the application of ad hoc and multi-hop concepts in cellular communication system. Furthermore, mobile ad hoc networks can also be applied to high speed WLANs to solve the capacity problem.

The wide range of potential application has led to a recent rise of research and development activities around the world in the area of mobile ad hoc networking. However, the benefits from mobile ad hoc networks are at the expense of some additional networking complexity, especially when adopting wireless routing algorithms to support dynamic topology structure. For at least a decade, wireless routing has been an active research topic in mobile and wireless area. As mobile and wireless technologies proliferate, this area is gaining more and more attention, and there are more enterprises and standards involved, such as IETF's MANET group, ATM Forum's Mobile ATM and a number of efforts in 3G wireless standards and so forth. In spite of such great emphasis in ad hoc routing protocols, there is no one protocol that can be suitable for all applications yet. Wireless routing is still a challenging research topic due to the mobility of mobile nodes in ad hoc networks.

The routing issue in mobile ad hoc networks is more challenging than that in traditional networks. First, in traditional solutions such as that of infrastructure-based cellular networks, it's assumed that the network topology structure is relatively steady, while the topology of ad hoc networks (infrastructure-based systems with multi-hop and ad hoc functions enabled and those without fixed infrastructure) is varying constantly. Second, traditional routing solutions are dependent on the distributed routing database stored in some network nodes or specified management nodes, but for mobile ad hoc networks, routing information is unlikely to be stored permanently in some nodes, and furthermore the information stored in the nodes is not always real and reliable. Therefore, in traditional infrastructure-based cellular networks, route computation is usually centralized and can be easily implemented, while in mobile ad hoc networks, route computation must be distributed because centralized routing in a dynamic network is impossible even for a fairly small network.

In general, the distributed routing is realized by the Bellman-Ford algorithm in mobile ad hoc network, where a mobile node tells other nodes its route cost to the destination node and then other nodes will calculate the total route cost to the destination node by combining the route cost indicated in the received response message from the mobile node and the route cost of each other node to the mobile node, and the source node will choose to relay over the node through which the total route cost to the destination node is the lowest. Most of the present routing protocols and algorithms are variations based on Bellman-Ford, only with different cost focus, such as system overhead, packet latency, battery consumption, transmission power, memory storage, system stability and so on.

The basic idea of Bellman-Ford algorithm can be illustrated as FIG. 2, wherein the circle indicates the mobile node, the connecting line between circles indicates an existing wireless link and the data on the line indicates the hop cost for forwarding packets from one node to another node involved in the radio connectivity. The hop cost can be one or a group of performance parameters for the hop or node, such as system overhead, packet latency, battery consumption, transmission power, memory storage, node mobility and so on. Costs for different performances are normalized to measure unit with the same weight.

In the following, as an example for finding the route from node A to node T, we will describe how the above Bellman-Ford algorithm works.

First of all, before describing the routing method, let's assume that the network system satisfies the following three conditions:

(1) Route probing signals from node A can reach nodes with different range at different transmission power.

(2) Node A may or may not have direct reachable link with node T. When the cost value exceeds a certain set value, the link can be taken as practically unreachable.

(3) When the cost on the link between node X1 to node X2 is low, the transmission power of the transmitting node can be reduced so as to reduce the system interference.

With the above three assumed conditions, the process to find the best route (lowest cost) from node A to node T, comprises:

(1) Node A sends route probing signals at a certain transmission power, and the node which received the route probing signals will send back response message to node A if it has routes to node T, and forward the route probing signals if it has no route list to node T. In FIG. 2, node B and node G received the route probing signals from node A respectively.

(2) Node B or Node G will check its own route list. If there is a route to node T in the route list, the related route list will be sent to node A; if there is no available route to node T in the route list, the route probing signals will be forwarded. In FIG. 2, node C and H received the forwarded route probing signals from node B and node G respectively.

(3) Node C has two routes to node T as C-D-T (8+8) and C-T (20) respectively. Node C compares the cost of the two routes and will respond to node B with its lowest cost route to node T as C-D-T (16). Of course, it can also respond to node B with the two routes to node T with cost indication.

(4) Node B will respond to node A with its best route to node T as B-C-D-T (10+16). Of course, node B can also respond to node A with its entire routes to node T as B-T (40), B-C-D-T (26) and B-C-T (32).

(5) Similar to node B, node G will respond to node A with its best route to node T as G-H-I-J-T (27) or its entire routes to node T as G-T (42), G-H-K (32) and G-H-I-J-T (27).

(6) Node A obtains its route to node T through the above probing procedure. If the node that received the route probing signals responds to the involved forwarding node only with the lowest cost route, node A will obtain its three routes to node T as A-G-H-I-J-T (35), A-B-C-D-T (46) and A-T (120). If the node that received the route probing signals responds to the involved forwarding node with all possible routes, node A will receive seven routes as shown in Table. 1.

(7) According to the lowest cost rule, node A will select A-G-H-I-J-T (35) as its current route to node T no matter how many hops the route has.

The route cost calculation can be expressed as:

$${f}_{cost\_dbf} = {\sum }_{n = 1}^{N} C ( n ) \qquad ( 1 )$$

Where n=1, 2, . . . , N is the hop sequence on the route and N is the total number of hops on the route, C(n) is the cost corresponding to the nth hop, such as transmission power, node latency and so on.

Table 1 summarizes the route calculation and selection from mobile node A to mobile node T based on Bellman-Ford algorithm. The first column lists all possible routes from source node A to destination node T, the second column to the sixth column are the hop cost between the involved nodes on the route list, the seventh column is the number of hops for the related route, and the last column is the computation results of total cost of all hops on the route based on Bellman-Ford Algorithm. According to the lowest cost rule, the best route should be A-G-H-I-J-T, which takes only cost of 35 units while others are more than 35 units. Routes with the same total cost units are regarded as having the same quality no matter how many hops are included on each route.

TABLE 1
Route list and computation based on Bellman - Ford's Algorithm

| | | | | | | Number Of | Total |
|---|---|---|---|---|---|---|---|
| Route node list | Hop1 | Hop2 | Hop3 | Hop4 | Hop5 | hops | Cost |
| A-T | 120 | | | | | 1 | 120 |
| A-B-T | 20 | 40 | | | | 2 | 60 |
| A-G-T | 8 | 60 | | | | 2 | 68 |
| A-B-C-T | 20 | 10 | 22 | | | 3 | 52 |
| A-B-C-D-T | 20 | 10 | 8 | 8 | | 4 | 46 |
| A-G-H-K-T | 8 | 6 | 20 | 6 | | 4 | 40 |
| A-G-H-I-J-T | 8 | 6 | 5 | 8 | 8 | 5 | 35 |

Bellman-Ford algorithm and its variations provide a really good solution to hop-by-hop optimal route computation to select the lowest cost route. However, because the cost is determined hop-by-hop and the cost determination on the hop only involves the related nodes and the radio link between them, and therefore the cost concept herein fails to consider the impact on the system performance when a new hop is introduced. Additionally, these algorithms are impliedly assumed that the relationship between the total cost and all one-hop link cost is linear, but the assumption cannot always stand true. For example, the cost such as transmission power (dB) or packet latency on node is linear for all nodes on the route, but there are some exceptions for other performance parameters due to the following reasons:

(1) When the route contains several mobile nodes, the connectivity possibility of the whole route should be a product of the connectivity probability of every single hop. That means the relationship of connectivity probability of each single hop is multiplicative when all related links are combined to an integrated route. When the selected best route is broken due to the changing topology introduced by mobility, more effort is needed to find a new route. More hops on route mean that the connectivity probability is lower and effort needed for maintaining the route is more.

(2) When a new node is introduced to the route, it will forward data or respond to the node of its last step with neighbor list. This behavior seems to be proliferation of node tree, and meanwhile the resource overhead for route discovery and maintenance increases nonlinearly.

(3) When the data packet is forwarded from the source node to the destination node, the resource needed for the service depends on the number of hops on current existing route. The increase of resource overhead is also dependent on current system load and the number of hops on current existing route.

As described above, radio route cost involves not only the radio link cost of each hop, but also the number of hops contained in the link, so current Bellman-Ford algorithm has its shortcoming when being adopted to select the optimal route.

### SUMMARY OF THE INVENTION

The present invention proposes a new routing method and a mobile terminal to execute the method. The routing method weights the route cost with the number of hops on the route to address the problems introduced by hop-by-hop optimization.

A routing method is proposed, executed by a mobile terminal in wireless communication systems in accordance with the present invention, comprising: (i) receiving route probing signals to the destination mobile terminal from another mobile terminal; (ii) calculating the route cost to the destination mobile terminal via said mobile terminal according to the route probing signals and system performance parameters; (iii) sending response messages to said another mobile terminal according to the calculated route cost.

### BRIEF DESCRIPTION OF THE DRAWING

FIG. 1 is a block diagram illustrating the application of multi-hop concept in cellular communication systems;

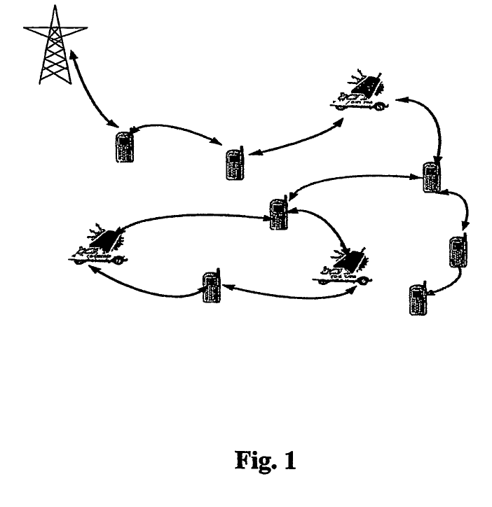

FIG. 2 is a schematic diagram illustrating the route selection based upon Bellman-Ford algorithm;

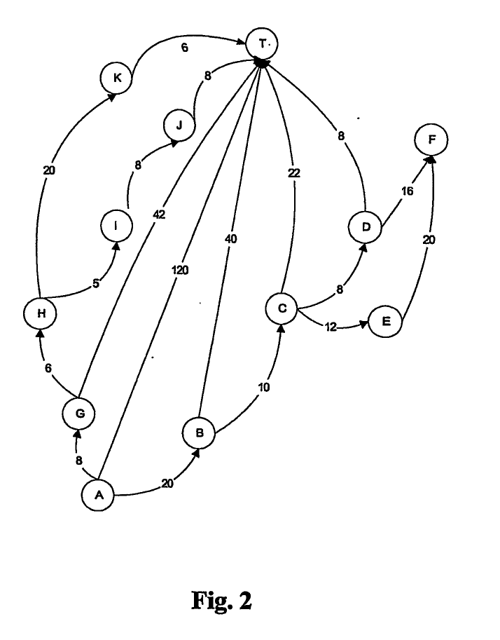

FIG. 3 is a schematic diagram illustrating the route selection in accordance with the present invention.

### DETAILED DESCRIPTION OF THE INVENTION

The new routing method proposed in the present invention is still based on distributed Bellman-Ford routing algorithm, but it introduces weighting with the number of hops for route cost computation. The main idea of the new routing method is to classify the route cost into hop-by-hop cost and hop-in-all cost according the different characteristics of cost performance parameters. This can be expressed as:

$${f}_{cost\_new} = {f}_{1} ( N ) + {f}_{2} ( N ) \cdot {\sum }_{n = 1}^{N} C ( n ) \qquad ( 2 )$$

Where n=1, 2, . . . , N is the hop sequence on the route and N is the number of hops on the route, C(n) is the cost corresponding to the nth hop, and the cost may take several parameters into consideration such as transmission power, node latency, and etc. f₁(N) is cost compensation function for system performance such as compensation for system resource overhead, and f₂(N) is cost adjusting function for link performance such as adjusting function for link connectivity or potential interference. Both f₁(N) and f₂(N) are functions which can be determined experimentally or by current system parameters. When f₁(N)=0 and f₂(N)=1, the new routing scheme will converge to the distributed Bellman-Ford algorithm. Taking all performance parameters into consideration, C(n) can be expressed as follows:

C(n)=wₚfₚ(P₁)+w_{d}f_{d}(Delay)+w_{b}f_{b}(Battery)+w_{c}f_{pc}(Proc_capability)+wₘfₘ(memory)+w_{mb}f_{mb}(mobility) (3)

In above equation (3), wₓ represents the weight of each performance parameter, fₓ is the function of the mapping relationship between performance parameters and the measurement we consider in route selection. Where wₚ is the weight of transmission power, w_{d} is the weight of transmission delay, f_{b} is the weight of the battery of the node, w_{c} is the weight of the processing capability of the node, wₘ is the weight of the memory of the node, and w_{mb} is the weight of the mobility of the node. Other performance parameters can also be added into this equation. P₁ is the transmission power of the nth hop, Delay is the transmission delay of the nth link, Battery is the battery volume the nth node as the relayer, Proc_capability is the processing capability of the nth node, memory is the memory space of the nth node, and mobility is the mobility of the nth node which can be measured with moving velocity.

All the above weights wₓ and mapping functions including f₁ and f₂ can be determined through experiment and the state of the network. We will demonstrate a simple example to illustrate the routing scheme in the present invention. In this embodiment, we only take three factors into consideration: total transmission power, total delay and system overhead, and it's assumed that all mapping functions satisfy the following condition:

$${f}_{p} ( {P}_{t} ) = \frac{{P}_{t}}{{P}_{b}} \qquad ( 4 )$$

Where P_{b} is the basic power we set and Pₜ is the transmission power of the node.

$${f}_{d} ( Delay ) = \frac{Delay}{{Delay}_{b}} \qquad ( 5 )$$

Where Delay is the link's transmission delay and Delay_{b} is the set basic transmission delay.

We also assume all weights as follows:

wₚ=0.6, w_{d}=0.4, w_{b}=0.0, w_{c}=0.0, wₘ=0.0, w_{mb}=0.0

If each direct link can be expressed as X→Y(a,b,c,d,e,f), wherein a represents fₚ between node X and node Y, b represents f_{d} between node X and node Y, c represents f_{b} of node Y, d represents f_{pc} of Y, e represents fₘ of Y, f represents f_{mb} of node Y relative to node X. If node Y is the destination node, f_{b}, f_{pc}, fₘ are all set to 0. But in the embodiment of the present invention, we only take total transmission power and total delay into consideration, so we can express each direct link as X→Y(a,b).

In order to clarify the routing scheme of the present invention, f₁(N)and f₂(N) can be simply assumed as:

f₁(N)=2^{N-1} (6)

f₂(N)=1 (7)

So, equation (2) can be simplified as:

$${f}_{cost\_new} = {f}_{1} ( N ) + {f}_{2} ( N ) \cdot {\sum }_{n = 1}^{N} C ( n ) = {2}^{N - 1} + {\sum }_{n = 1}^{N} C ( n ) \qquad ( 8 )$$

f₁(N) can be explained as the system resource overhead introduced by a new hop, and it increases exponentially with the increasing of the total hops. C(n) can be explained as the transmission power cost to overcome the path loss between two nodes and f₂(N)=1 means no hop-by-hop weighting is assumed.

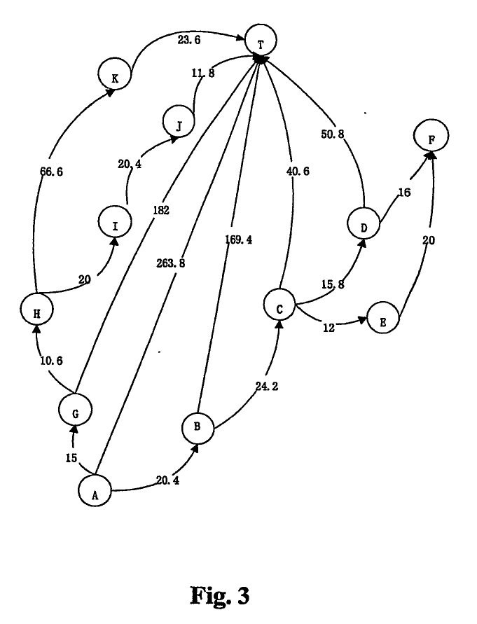

In the following, FIG. 3 is also taken as an example for describing how to find the route from node A to node T with the method proposed in the present invention.

We assume all nodes in FIG. 3 have the same processing capability and their channel environments are the same (for example, each node is in free space), thus each node in the figure can be expressed as:

$$A -> G ( 5 , 30 )$$

$$\sum C ( n ) = {0.6}^{*} 5 + {0.4}^{*} 30 = 15$$

$$G -> H ( 11 , 10 )$$

$$\sum C ( n ) = {0.6}^{*} 11 + {0.4}^{*} 10 = 10.6$$

$$H -> K ( 91 , 30 )$$

$$\sum C ( n ) = {0.6}^{*} 91 + {0.4}^{*} 30 = 66.6$$

$$K -> T ( 26 , 20 )$$

$$\sum C ( n ) = {0.6}^{*} 26 + {0.4}^{*} 20 = 23.6$$

$$H -> I ( 20 , 20 )$$

$$\sum C ( n ) = {0.6}^{*} 20 + {0.4}^{*} 20 = 20$$

$$I -> J ( 14 , 30 )$$

$$\sum C ( n ) = {0.6}^{*} 14 + {0.4}^{*} 30 = 20.4$$

$$J -> T ( 13 , 10 )$$

$$\sum C ( n ) = {0.6}^{*} 13 + {0.4}^{*} 10 = 11.8$$

$$G -> T ( 270 , 50 )$$

$$\sum C ( n ) = {0.6}^{*} 270 + {0.4}^{*} 50 = 182$$

$$A -> T ( 393 , 70 )$$

$$\sum C ( n ) = {0.6}^{*} 393 + {0.4}^{*} 70 = 263.8$$

$$B -> T ( 249 , 50 )$$

$$\sum C ( n ) = {0.6}^{*} 249 + {0.4}^{*} 50 = 169.4$$

$$B -> C ( 27 , 20 )$$

$$\sum C ( n ) = {0.6}^{*} 27 + {0.4}^{*} 20 = 24.2$$

$$C -> E ( 5 , 20 )$$

$$\sum C ( n ) = {0.6}^{*} 5 + {0.4}^{*} 20 = 11$$

$$C -> D ( 13 , 20 )$$

$$\sum C ( n ) = {0.6}^{*} 13 + {0.4}^{*} 20 = 15.8$$

$$C -> T ( 41 , 40 )$$

$$\sum C ( n ) = {0.6}^{*} 41 + {0.4}^{*} 40 = 40.6$$

$$D -> F ( 11 , 20 )$$

$$\sum C ( n ) = {0.6}^{*} 11 + {0.4}^{*} 20 = 14.6$$

$$E -> F ( 44 , 40 )$$

$$\sum C ( n ) = {0.6}^{*} 44 + {0.4}^{*} 40 = 42.4$$

$$A -> B ( 14 , 30 )$$

$$\sum C ( n ) = {0.6}^{*} 14 + {0.4}^{*} 30 = 20.4$$

$$D -> T ( 58 , 40 )$$

$$\sum C ( n ) = {0.6}^{*} 58 + {0.4}^{*} 40 = 50.8$$

With the above assumption, the process to find the best route from source node A to destination node T is as follows:

(1) Node A sends route probing signals at certain transmission power and the node that received the route probing signals will send back response message to node A if it has routes to node T, otherwise it will forward the route probing signals. In FIG. 3, node B and node G received the route probing signals from node A respectively.

(2) Node B or Node G will check its own route list and respond to node A with the relevant route list if it has route to node T on its route list or forward the route probing signals if it has no available route to node T on its route list. In FIG. 3, node C and node H received the forwarded route probing signals from node B and node G respectively.

(3) Node C has two routes to node T as C-D-T and C-T respectively. When node C compares the cost of the two routes, it not only sums up the link cost on its route to C as A-B-C but also combines the knowledge about the route probing signals forwards route (cost and number of hops). If only the lowest cost route will be returned to the route probing signals forwarding node (node B), the route cost computation will take place at node C. If all reachable routes will be returned to the route probing signals forwarding node (node B) and therefore to the source node (node A), the route cost computation will take place at node A. When in the former situation (the route cost is computed at node C), the route probing signals received by node C should include probing forwarding route information (cost of each hop and hops). While in the latter situation (the route cost is computed at node A), such information is optional. The calculation rule in both situations should conform to equation (2). That means the cost calculation is for the entire route which contains two parts: the route from source node A to current node C and that from current node C to destination node T.

$$\begin{matrix}For route A - B - C - D - T , \\ N = 4 , {\sum }_{n = 1}^{N} C ( n ) = 20.4 + 24.2 + 15.8 + 50.8 = 111.2 \\ {f}_{cost\_new} = {2}^{4 - 1} + 111.2 = 119.2 & ( i ) \\ For A - B - C - T \\ N = 3 , {\sum }_{n = 1}^{N} C ( n ) = 20.4 + 24.2 + 40.6 = 85.2 \\ {f}_{cost\_new} = {2}^{3 - 1} + 85.2 = 89.2 & ( ii )\end{matrix}$$

According to the lowest route cost rule, node C will respond to node B with the route A-B-C-D-T as the lowest cost route via node B. Of course, node C can also return the link cost and hops of the two routes C-T and C-D-T to node T, thus the route costs of A-B-C-T (89.2) and A-B-C-D-T (119.2) can be computed respectively at node A through node B.

(4) Similar to node C, node B will calculate the cost for all its reachable routes according to equation (8). In fact, the cost calculation results for route via node C are available and included in node C's response message to node B. So node B need only calculate the related cost for the route A-B-T:

$$for the route A - B - T , \\ N = 2 , {\sum }_{n = 1}^{N} C ( n ) = 20.4 + 169.4 = 189.8$$

$${f}_{cost\_new} = {2}^{2 - 1} + 189.8 = 191.8$$

Compared with the cost of route A-B-C-T, the route to destination node T via node B is the route via node C, which means route A-B-C-D-T is returned to source node A as the lowest cost route via node B.

If the cost of each possible route is computed at source node A, node B can also respond to node A with the link overhead and hops of each route (A-B-T, A-B-C-T, A-B-C-D-T) via node B, so that the route cost of each possible route can be computed at node A.

(5) Similar to node B, node G will also calculate the cost for all its reachable routes according to equation (8). Node G will forward the route probing signals to node H. If node H has route lists to destination node T, the cost calculation for route by node H will contains two parts: the information of probing forwarding route (cost and hops) from source node A to current node H (A-G-H) and the information of potential route (cost and hops) from current node H to destination node T (H-K-T and H-I-J-T).

$$\begin{matrix}for the route A - G - H - I - J - T N = 5 , {\sum }_{n = 1}^{N} C ( n ) = 15 + 10.6 + 20 + 20.4 + 11.8 = 77.8 \\ {f}_{cost\_new} = {2}^{5 - 1} + 77.8 = 93.8 & ( i ) \\ for the route A - G - H - K - T \\ N = 4 , {\sum }_{n = 1}^{N} C ( n ) = 15 + 10.6 + 66.6 + 23.6 = 115.8 \\ {f}_{cost\_new} = {2}^{4 - 1} + 115.8 = 123.8 & ( ii )\end{matrix}$$

A-G-H-I-J-T has more hops than A-G-H-K-T, but the total hop-by-hop cost of A-G-H-I-J-T is lower than that of A-G-H-K-T, so route A-G-H-I-J-T will be responded to node A as the lowest cost route via node G according to the lowest route cost rule.

If the cost of each possible route is not computed at each forwarding node, but at source node A, similar to node B, node G will respond to node A with the link cost and hops of each possible route via node G (A-G-T, A-G-H-I-J-T, A-G-H-K-T), so that each route cost can be computed at node A.

(6) Both node B and node G will respond to node A with its lowest cost route. Node A will compare all the costs and select the lowest cost route as the best route to node T. In this embodiment, route A-B-C-T is selected as the best route.

If each route cost is computed at source node A, the cost and hops of all potential routes to the destination node will be responded to the source node A via each forwarding node, then the cost calculation can be done at source node A to select the lowest cost route as the best route to node T.

Table 2 summarized all potential routes from source node A to destination node T. It shows that the best route selection depends on not only the total hop-by-hop cost but also the hop-in-all cost complementation, which is directly related with the number of hops on the route.

TABLE 2
Route list and computation based on new route selection algorithm

| | | | | | | Hop- | | Hop- | |
|---|---|---|---|---|---|---|---|---|---|
| Route | | | | | | by- | Num | in- | |
| node | | | | | | Hop | Of | All | Total |
| list | H1 | H2 | H3 | H4 | H5 | cost | Hops | cost | Cost |
| A-T | 263.8 | | | | | 263.8 | 1 | 1 | 264.8 |
| A-B-T | 28.2 | 169.4 | | | | 197.6 | 2 | 2 | 199.6 |
| A-G-T | 15 | 182 | | | | 197 | 2 | 2 | 199 |
| A-B- | 28.4 | 24.2 | 40.6 | | | 85.8 | 3 | 4 | 89.8 |
| C-T | | | | | | | | | |
| A-B-C- | 28.4 | 24.2 | 15.8 | 50.8 | | 119.2 | 4 | 8 | 127.2 |
| D-T | | | | | | | | | |
| A-G-H- | 15 | 10.6 | 66.6 | 19 | | 115.8 | 4 | 8 | 123.8 |
| K-T | | | | | | | | | |
| A-G-H- | 15 | 10.6 | 20 | 20.4 | 11.8 | 77.8 | 5 | 16 | 93.8 |
| I-J-T | | | | | | | | | |

Although the physical characteristic and function definition for f₁(N), f₂(N) and C(n) in above embodiment is determined with assumption, they can be explained as different system parameters in different way depending on practical applications and system performance features. For example, f₁(N) can be explained as the average system overhead for route discovery and maintenance, and f₂(N) can be explained as the total delay on the route.

The above routing scheme proposed in the present invention can be implemented in computer software in mobile terminals, or computer software, or in combination of both software and hardware.

### BENEFICIAL RESULTS OF THE INVENTION

As described above, with regard to the wireless routing method as provided in the present invention, the effect of hops on route cost is introduced. This means, route cost is weighted through functions that can reflect the system performance parameters. The routing selection priority rule can be adjusted by adjusting f₁(N) and f₂(N)according to different performance parameters emphasis. Moreover, the routing scheme can limit the number of hops on the route by adjusting f₁(N) and f₂(N) to avoid probing flooding and help route converge, and therefore make the route discovery easier.

Although the distributed routing scheme has been shown and described with respect to exemplary embodiments of mobile ad hoc networks, it should be understood by those skilled in the art that the scheme is not limited to ad hoc networks, but also applicable to cellular mobile communication systems and WLANs with ad hoc or multi-hop functions enabled.

Although the present invention has been shown and described with respect to specific embodiment, it is to be understood by those skilled in the art that various changes, omissions and additions may be therein and thereto, without departing from the spirit and scope of the invention as defined by the appended claims.

1. A routing method in wireless communication systems to be performed by a mobile terminal, comprising:
receiving route probing signals to the destination mobile terminal from another mobile terminal;
calculating the route cost to the destination mobile terminal via said mobile terminal according to said route probing signals and system performance parameters;
sending response messages to said another mobile terminal according to the calculated route cost.

2. The method according to claim 1, further comprising:
forwarding said route probing signals to other mobile terminals in the route list of said mobile terminal;
acquiring each route cost to the destination mobile terminal via said other mobile terminals according to the response messages from said other mobile terminals;
wherein step (iii) includes:
comparing said calculated route cost with each said acquired route cost;
sending response messages to said another mobile terminal according to the comparison result.

3. The method according to claim 1, further comprising:
sending a route probing signal to each mobile terminal in the route list of said mobile terminal;
selecting the link to the destination mobile terminal according to the received response messages from each said mobile terminal.

4. The method according to claim 2, further comprising:
sending a route probing signal to each mobile terminal in the route list of said mobile terminal;
selecting the link to the destination mobile terminal according to the received response messages from each said mobile terminal.

5. The method according to claim 1, wherein:
said system performance parameters at least contain the number of hops of the wireless link from the source mobile terminal to the destination mobile terminal via said mobile terminal;
said route probing signals contain the route cost of each hop from the source mobile terminal to said mobile terminal.

6. The method according to claim 5, wherein step (ii) calculates with the following formula:
$${f}_{cost\_new} = {f}_{1} ( N ) + {f}_{2} ( N ) \cdot {\sum }_{n = 1}^{N} C ( n )$$
where:
f_{cost—new} is route cost;
N is the number of hops of the wireless link to the destination mobile terminal from the source mobile terminal via said mobile terminal;
f₁(N) is cost compensation function for system performance;
f₂(N) is cost adjusting function for link performance;
n is the hop sequence of the wireless link;
C(n) is the wireless route cost corresponding to the nth hop.

7. The method according to claim 6, wherein said cost compensation function for system performance f₁(N)=2^{N-1}.

8. A routing method according to wireless communication systems performed by a mobile terminal, comprising:
sending a route probing signal to each mobile terminal in the route list of said mobile terminal;
calculating the route cost to the destination mobile terminal via each said mobile terminal according to the received response messages and system performance parameters from each said mobile terminal;
comparing the cost of each said route to select the link to the destination mobile terminal.

9. The method according to claim 8, further comprising:
receiving route probing signals from another mobile terminal;
sending the information about the route cost to the destination mobile terminal via said mobile terminal to said another mobile terminal.

10. The method according to claim 8, further comprising:
forwarding said route probing signals to other mobile terminals in the route list of said mobile terminal;
sending the information about the route cost to the destination mobile terminal via said other mobile terminal to mobile terminals that sends route probing signals to said mobile terminal, according to the response messages from said other mobile terminals.

11. The method according to claim 9, further comprising:
forwarding said route probing signals to other mobile terminals in the route list of said mobile terminal;
sending the information about the route cost to the destination mobile terminal via said other mobile terminal to said another mobile terminal, according to the response messages from said other mobile terminals.

12. The method according to claim 8, wherein:
said system performance parameters at least contain the number of hops of the wireless link from the source mobile terminal to the destination mobile terminal via said mobile terminal.

13. The method according to claim 12, wherein step (ii) calculates with the following formula:
$${f}_{cost\_new} = {f}_{1} ( N ) + {f}_{2} ( N ) \cdot {\sum }_{n = 1}^{N} C ( n )$$
f_{cost—new} is route cost;
N is the number of hops of the wireless link to the destination mobile terminal from the source mobile terminal via said mobile terminal;
f₁(N) is cost compensation function for system performance;
f₂(N) is cost adjusting function for link performance;
n is the hop sequence of the wireless link;
C(n) is the wireless route cost corresponding to the nth hop.

14. The method according to claim 13, wherein said cost compensation function for system performance f₁(N)=2^{N-1}.

15. A mobile terminal, comprising:
a receiving means, for receiving route probing signals to the destination mobile terminal from another mobile terminal;
a calculating means, for calculating the route cost to the destination mobile terminal via said mobile terminal according to said route probing signals and system performance parameters;
a sending means, for sending response messages to said another mobile terminal according to the calculated route cost.

16. The mobile terminal according to claim 15, further comprising:
a forwarding means, for forwarding said route probing signals to other mobile terminals in the route list of said mobile terminal;
an acquiring means, for acquiring each route cost to the destination mobile terminal via said other mobile terminals according to the response messages from said other mobile terminals;
a comparing means, for comparing said calculated route cost with each said acquired route cost;
a sending means, for sending response messages to said another mobile terminal according to the comparison result.

17. The mobile terminal according to claim 15, wherein said sending means sends a route probing signal to each mobile terminal in the route list of said mobile terminal, further comprising:
a selecting means, for selecting the link to the destination mobile terminal according to the response messages from each said mobile terminal received by said receiving means.

18. The mobile terminal according to claim 15, wherein:
said system performance parameters at least contain the number of hops of the wireless link from the source mobile terminal to the destination mobile terminal via said mobile terminal;
said route probing signals contain the route cost of each hop from the source mobile terminal to said mobile terminal.

19. The mobile terminal according to claim 18, wherein said calculating means calculates route cost with the following formula:
$${f}_{cost\_new} = {f}_{1} ( N ) + {f}_{2} ( N ) \cdot {\sum }_{n = 1}^{N} C ( n )$$
where:
f_{cost—new} is route cost;
N is the number of hops of the wireless link from the source mobile terminal to the destination mobile terminal via said mobile terminal;
f₁(N) is cost compensation function for system performance;
f₂(N) is cost adjusting function for link performance;
n is the hop sequence of the wireless link;
C(n) is the wireless route cost corresponding to the nth hop.

20. A mobile terminal, comprising:
a sending means, for sending a route probing signal to each mobile terminal in the route list of said mobile terminal;
a calculating means, for calculating the route cost to the destination mobile terminal via each said mobile terminal according to the response messages from each said mobile terminal and the system performance parameters;
a comparing means, for comparing the cost of each said route to select the link to the destination mobile terminal.

21. The mobile terminal according to claim 20, wherein said system performance parameters at least contain the number of hops of the wireless link from the source mobile terminal to the destination mobile terminal via said mobile terminal;

22. The mobile terminal according to claim 21, wherein said calculating means calculates route cost with the following formula:
$${f}_{cost\_new} = {f}_{1} ( N ) + {f}_{2} ( N ) \cdot {\sum }_{n = 1}^{N} C ( n )$$
where:
f_{cost—new} is route cost;
N is the number of hops of the wireless link from the source mobile terminal to the destination mobile terminal via said mobile terminal;
f₁(N) is cost compensation function for system performance;
f₂(N) is cost adjusting function for link performance;
n is the hop sequence of the wireless link;
C(n) is the wireless route cost corresponding to the nth hop.
